(19) United States
(12) Patent Application Publication
(10) Pub. No.: US 2026/0172961 A1
(43) Pub. Date: Jun. 18, 2026

(54) SYSTEM AND METHOD FOR DETECTING BEACON TRANSMISSION TIMING DEVIATIONS IN WIRELESS NETWORKS

(71) Applicant: Beken Corporation, Shanghai (CN)

(72) Inventors: Qiang SUN, Shanghai (CN); Yin Wang, Shanghai (CN); Guochu Chen, Shanghai (CN)

(73) Assignee: Beken Corporation, Shanghai (CN)

(21) Appl. No.: 19/016,903

(22) Filed: Jan. 10, 2025

(30) Foreign Application Priority Data
Dec. 13, 2024 (CN) 202411852707.5

(51) Int. Cl. H04W 52/02; H04W 74/0816

(52) U.S. Cl. CPC H04W 52/0212; H04W 52/0229; H04W 74/0816

(57) ABSTRACT

A system and method are provided for adaptively optimizing client station wake-up schedules in wireless networks for efficient and reliable communication. By analyzing one or more received beacon frames and classifying them as current or preceding, the client station determines if the access point transmits beacon frames early. In response to detecting that the received beacon frame is a current beacon frame, a lead time is calculated based on transmission time and target time of the received beacon frame. The client station uses the lead time to wake up early enough to reliably receive beacon frames while minimizing unnecessary power usage.

### CROSS-REFERENCE TO RELATED APPLICATIONS

This application claims priority to and incorporates by reference Chinese patent application no. 202411852707.5 filed 13 Dec. 2024.

### TECHNICAL FIELD

The technical field of the present disclosure generally relates to wireless communications, and more specifically, a system and method for adaptive wake-up schedule optimization for client stations in wireless networks.

### BACKGROUND

This disclosure relates generally to wireless communication systems, and more particularly a wireless network (e.g., WLAN). In a wireless network, an access point periodically transmits beacon frames to announce the presence of the network and allow client stations to connect and stay connected. To conserve battery, battery-powered client stations like phones and laptops usually enter a power-saving mode in between data transmissions.

### BRIEF SUMMARY

A method for adaptive optimization of wake-up schedules of a client station involves predicting, by one or more processors of a client station, a target beacon transmission time (TBTT); receiving, by a transceiver of the client station, a beacon frame from an access point, the beacon frame comprising a transmission time according to an access point's clock; determining, by the one or more processors of the client station, that the transmission time is smaller than the TBTT, indicating that the beacon frame is sent ahead of the TBTT; performing, by the one or more processors of the client station, a beacon frame classification process in response to determining that the transmission time is smaller than the TBTT; determining, by the one or more processors of the client station, that the access point sends beacon frames ahead of TBTTs based on the received beacon frame is determined to be a current beacon frame in the beacon frame classification process; determining, by the one or more processors of the client station, a lead time based on the transmission time and the TBTT; and waking, by the one or more processors of the client station, the client station at the lead time before subsequent TBTTs to receive subsequent beacon frames.

In an embodiment, a client station comprising one or more processors and a non-transitory memory storing instructions that, when executed by the one or more processors, configure the client station to perform these steps.

In another embodiment, a non-transitory computer-readable storage medium containing instructions that, when executed by a computer, causes the computer to perform these steps.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic diagram illustrating a network environment, according to some examples.

FIG. 2 is a block diagram illustrating example components of a client station, according to some examples.

FIG. 3 is a conceptual diagram illustrating components of an example beacon frame and a timeline illustrating beacon frame transmissions from an access point and the client station wake-up times for receiving the beacon frames, according to some examples.

FIG. 4 is a conceptual diagram showing two timelines illustrating example timings for transmitting beacon frames from the access point to the client station with network traffic, according to some examples.

FIG. 5 is a conceptual diagram showing two timelines illustrating an example beacon frame classification process, according to some examples.

FIGS. 6A and 6B are flowcharts showing a method for adaptive optimization of a wake-up schedule for the client station, according to some examples.

FIG. 7 is a diagrammatic representation of the client station, according to some examples.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. In the examples provided below, time units are described in milliseconds (ms), however, the systems and method are not limited to any particular time units. In some examples, microseconds (μs) are used instead of ms to obtain more precise time values.

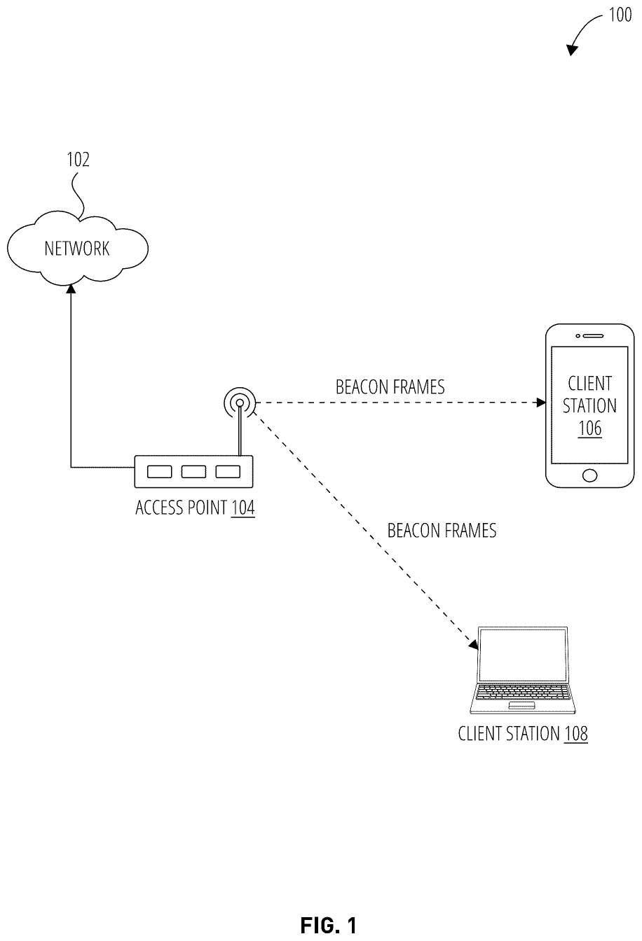

FIG. 1 is a schematic diagram illustrating a network environment 100, according to some examples.

Network environment 100 includes a network 102, an access point 104, a client station 106, and client station 108. Network environment 100 represents a configuration of devices and connections within a wireless communication environment.

Access point 104 is connected to network 102, serving as an intermediary between network 102 and wireless devices, such as client station 106 and client station 108. Client station 106 can be included in a device like a smartphone or a laptop. Client station 106 wirelessly connects to network 102 through access point 104. This connection enables client station 106 to access network resources, communicate with other devices, and exchange data. In some examples, client station 106 acts as an access point 104 from the prospective of client station 108.

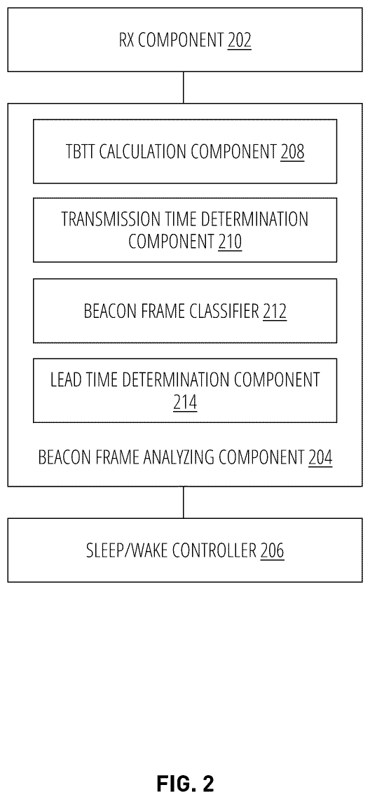

FIG. 2 is a block diagram illustrating example components of a client station, according to some examples.

Client station 106 includes an RX component 202, a beacon frame analyzing component 204, and a sleep/wake controller 206. RX component 202 is communicatively connected to beacon frame analyzing component 204, and beacon frame analyzing component 204 is communicatively connected to sleep/wake controller 206.

RX component 202 receives wireless signals at client station 106. In some examples, wireless signals received by client station 106 include beacon frames broadcast from access point 104.

The beacon frame analyzing component 204 analyzes received beacon frames. The beacon frame analyzing component 204 may further includes a target beacon transmission time (TBTT) calculation component 208, a transmission time determination component 210, a beacon frame classifier 212, and a lead time determination component 214.

TBTT calculation component 208 calculates TBTTs of beacon frames. TBTTs may refer to the scheduled times for access point 104 to transmit a beacon frame. Beacon frames may be transmitted by access point 104 at regular intervals to maintain connection with and/or give information to client stations and/or APs in network 102. Each beacon frame has a corresponding TBTT that specifies when each beacon frame should be sent by access point 104. A given beacon frame can be referred to as a “preceding”, “current”, or “subsequent” beacon frame in relation to other beacon frames. Specifically, a preceding beacon frame has a corresponding preceding TBTT and refers to a beacon frame transmitted before the current beacon frame. A subsequent beacon frame has a corresponding subsequent TBTT and refers to a beacon frame transmitted after the current beacon frame. TBTTs serves as targets or goals for access point 104 to transmit beacon frames at predefined times. However, the actual transmission time of a beacon frame may vary from the TBTT due to factors like network congestion, manufacturer's settings, and/or configurations. Generally, at or near a current TBTT, a current beacon frame corresponding to the current TBTT should be received; however, a preceding beacon frame corresponding to a preceding TBTT may be received at or near the current TBTT due to Internet traffic delay.

The transmission time determination component 210 may determine a transmission time of a received beacon frame. In some examples, the transmission time indicates the time when a beacon head is transmitted to the air interface. In some examples, the transmission time determination component 210 determines the transmission time of a received beacon frame based on a timestamp (e.g., a TSF value) extracted from the received beacon frame. Alternatively, transmission time determination component 210 may determine the transmission time based on when client station 106 receives the received beacon frame. In some examples, the transmission time determination component 210 determines that the transmission time is smaller than the calculated TBTT, indicating the received beacon frame was sent ahead of its corresponding TBTT.

The beacon frame classifier 212 classifies the received beacon frame. For example, beacon frame classifier 212 determines that the received beacon frame is a current beacon frame based on a wireless medium has remained unoccupied for one or more predetermined time periods after receiving the received beacon frame (i.e., has not received an additional beacon frame that was intended for the current TBTT). The wireless medium may refer to a radio frequency (RF) channels or bandwidth that wireless signals, including beacon frames, are transmitted over between devices (e.g., access points, client stations, etc.) in the wireless network (e.g., network 102). It acts as the communication medium for the wireless network.

The lead time determination component 214 calculates one or more lead times based on transmission times and TBTTs of one or more current beacon frames.

The sleep/wake controller 206 wakes up the client station 106 at the calculated lead time before subsequent TBTTs to receive subsequent beacon frames. This allows client station 106 to reliably receive beacon frames from access point 104 that sends beacon frames ahead of TBTTs.

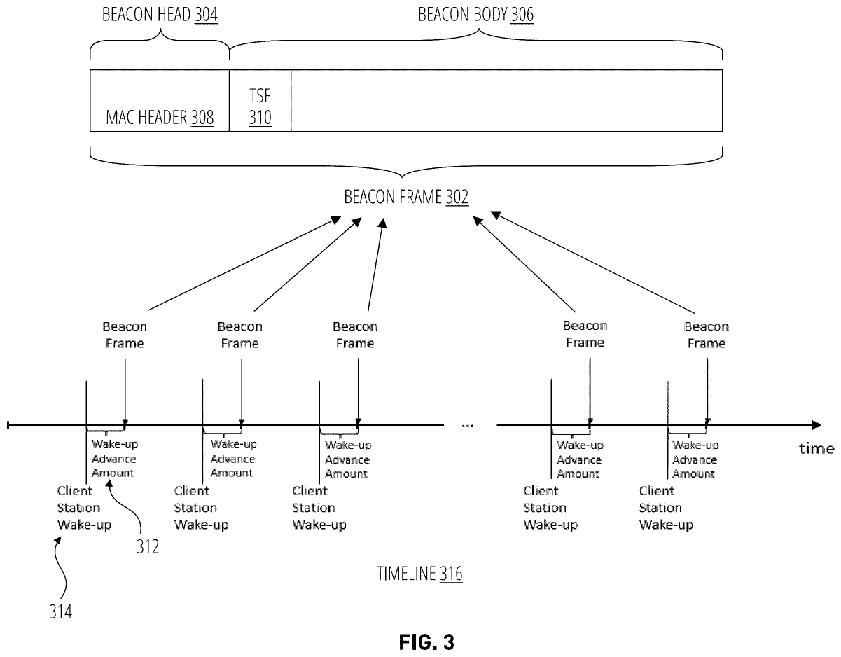

FIG. 3 is a conceptual diagram illustrating components of an example beacon frame and a timeline illustrating beacon frame transmissions from an access point and the client station wake-up times for receiving the beacon frames, according to some examples.

A timeline 316 illustrates the intervals in which the beacon frames 302 are transmitted from access point 104 to client station 106 and the timing of the client station 106 waking up to receive the beacon frames 302.

The beacon frame 302 includes a beacon head 304 and a beacon body 306.

The beacon head 304 is a first section of a beacon frame. In some examples, the beacon head 304 is the first 24 bytes of the beacon frame. In some examples, the beacon head 304 is a wireless media address control (MAC) Header 308. MAC Header 308 indicates a type of the frame. In some examples, MAC Header 308 indicates that the frame transmitted is a beacon frame.

Beacon body 306 may include other information carried by beacon frame 302. In some examples, beacon body 306 includes a timing synchronization function (TSF) 310. TSF 310 is a counter that indicates a length of time since access point 104 has powered on. In other words, TSF 310 may be a timestamp indicating when a TSF field of the beacon frame is transmitted to the air interface.

Timeline 316 illustrates periodic transmissions of beacon frames from access point 104 to client station 106, lead times 312 calculated by client station 106, and the timing of client station 106 waking up from a power-saving mode before the transmission of each beacon frame according to lead time 312. After receiving the beacon frame the client station 106 may go back to the power-saving mode (e.g., sleep) until client station 106 wakes up in a next interval.

Lead time 312 is an amount of time before a TBTT of a corresponding beacon frame is expected to be transmitted. Client station 106 may wake up from the power-saving mode at lead time 312 before the TBTT. If lead time 312 is too large, client station 106 may wake up earlier than necessary, wasting energy; however, if lead time 312 is too small, client station 106 may wake up too late and miss the corresponding beacon frame. Lead time 312 may account for one or more factors. In some examples, lead time 312 includes one or more components that account for the time required for hardware components to prepare for receiving data (e.g., powering on RX component 202) and for a buffer to account for access point 104 transmitting beacon frames earlier than TBTTs. In a specific example, with a lead time of 2 ms and a subsequent TBTT of 302.4 ms, client station 106 wakes up from the power-saving mode at 300.4 ms.

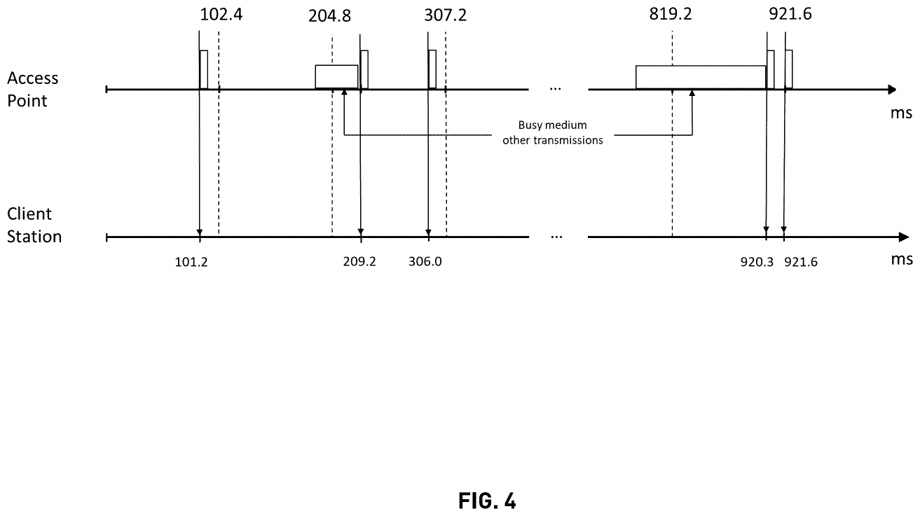

FIG. 4 is a conceptual diagram showing two timelines illustrating example timings for transmitting beacon frames from the access point to a client station with network traffic, according to some examples.

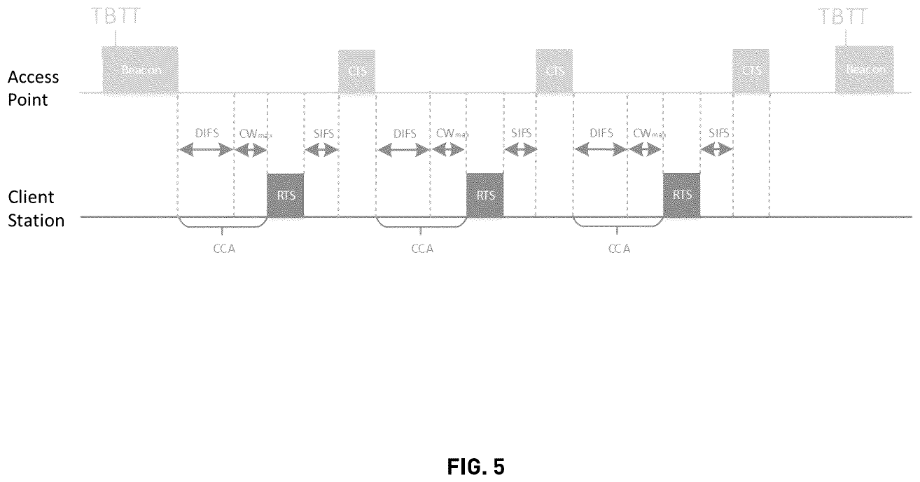

In some examples, access point 104 intentionally transmits beacon frames 302 ahead of the TBTTs due to various reasons such as accommodating for network congestion. For the example illustrated in FIG. 4, access point 104 transmits beacon frames 1.2 ms ahead of TBTT. A TBTT of a first beacon frame is 102.4 ms, but access point 104 transmits the first beacon frame at 101.2 ms, ahead of 102.4 ms. A TBTT of a second frame is 204.8 ms, but access point 104 tries to transmit the second beacon frame ahead of the TBTT of the second beacon frame; however, due to Internet traffic, access point 104 is not able to transmit the second beacon frame at a scheduled time (e.g., 204.8−1.2=203.6 ms), so access point 104 waits until a radio interface (e.g., wireless medium, radio frequency interface, radio communication interface) is idle before sending the second beacon frame at 209.2 ms. A TBTT of a third beacon frame is 307.2 ms, but access point 104 transmits the third beacon frame at 306.0 ms, 1.2 ms ahead of its TBTT. A TBTT of an eighth beacon frame is 819.2 ms, and access point 104 tries to send the eighth beacon frame at 818.0 ms, but access point 104 is not able to transmit the eighth beacon frame at 818.0 ms due to Internet traffic, so access point 104 transmits the eighth beacon frame at 920.3 ms in response to the wireless medium being unoccupied. In response to receiving the eighth beacon frame at 920.3 ms, which is close to a ninth TBTT, client station 106 needs to determine whether the eighth beacon frame is the ninth beacon frame sent ahead of the ninth TBTT or is it the eighth beacon frame that is delayed. To make that determination, client station 106 waits for the predetermined time period to see if it receives a ninth beacon frame (i.e., current beacon frame); if yes, this indicates that the eighth beacon frame was the eighth beacon frame (i.e., a preceding beacon frame) that was delayed; if no, this indicates that the received beacon frame is the current beacon frame. A length of the predetermined time period will be discussed in the description of FIG. 5.

FIG. 5 is a conceptual diagram showing two timelines illustrating an example beacon frame classification process, according to some examples.

As discussed above, the CCA allows client station 106 to check for additional transmissions based on radio frequency (RF) signals and/or energy levels in the wireless medium: if RF signals and/or energy levels are above a predetermined threshold, client station 106 determines that there is one or more additional transmissions. Alternatively, if no RF signals and/or energy levels exceed the predetermined threshold, client station 106 determines that the wireless medium remains unoccupied when the CCA is performed. In some examples, access point 104 periodically transmits beacon frames at or near TBTTs. In response to receiving or transmitting the received beacon frame, client stations (e.g., client station 106) and/or APs with data to transmit must wait for a Distributed InterFrame Space (DIFS) before transmitting, to allow the wireless medium to stay clear. In some examples in which multiple client stations and/or APs are ready to transmit after DIFS, a random backoff mechanism is used to avoid collisions. A backoff time is a random value between 0 and Contention Window (CW), where CW starts at CW minimum (CWMin) and increases exponentially up to CW Maximum (CWMax) with successive collisions. In some examples, a duration of the CCA process is equal to the combined durations of the DIFS and CWMax. In some examples, the backoff mechanism allows client stations and/or APs to defer their transmission for a random amount of time based on the current Contention Window size, aiming to minimize collisions. Therefore, to determine whether the additional beacon frame will be received, client station 106 may need to wait for the predetermined time period comprising a combined duration of both the DIFS and the CWMax. By waiting for the predetermined time period equal to DIFS+CWMax after receiving the received beacon frame, client station 106 allows sufficient time to elapse when any additional beacon frame transmission would be expected to occur. If no additional transmission is detected throughout this time (i.e., failure to receive the additional beacon frame), client station 106 can conclude that the received beacon frame is likely the current beacon frame rather than a preceding beacon frame that was delayed.

In some examples, client station 106 sends a Request to Send (RTS) to access point 104 after the predetermined time period. In some examples, after client station 106 sends the RTS, the AP is busy and not able to respond to the RTS due to reasons such as ongoing data transmission from hidden nodes. In other examples, in response to receiving the RTS, access point 104 may transmit a Clear to Send (CTS), notifying all client stations, APs, and/or hidden nodes in network 102 to wait for a current transmission to finish, thereby gaining control over the radio interface. Additionally, access point 104 may also transmit a pending non-beacon packet and/or pending beacon frame that was not sent due to a busy wireless medium, because the RTS has reserved the wireless medium, access point 104 can send the pending non-beacon packet and/or pending beacon frame after the CTS.

Once the RTS-CTS exchange (i.e., sending the RTS and receiving the CTS) is complete, all client stations would then need to wait for a DIFS period before contending again. After DIFS, the random backoff mechanism may be used again. Client stations select random backoff times between 0 and the current CW value. If collisions continue, CW will exponentially increase again up to the CWMax. Therefore, to determine whether the current beacon frame will be received, client station 106 waits for another one of the predetermined time periods (i.e., the combined duration of the DIFS and the CWMax).

In some examples, a cycle of sending the RTS, receiving the CTS, and checking for the additional transmissions during the predetermined time period may be repeated by client station 106 one or more times until there is insufficient remaining time for another one of the cycles before the subsequent TBTT. In other words, client station 106 may first determine whether there is sufficient remaining time to complete another one of the cycles before needing to receive the subsequent beacon frame. If there is insufficient remaining time, client station ends the determining process by determining that the received beacon frame is the current beacon frame and prepares to receive the subsequent beacon frame at and/or ahead of the subsequent TBTT.

In some examples, client station 106 calculates the remaining time based on the subsequent TBTT, an ending of one of the predetermined time periods, and/or a current time value according to the client station's clock, and then determines whether there is sufficient remaining time by comparing the remaining time with a time required for the RTS-CTS exchange and an additional predetermined time period. In some other examples, client station 106 adds the time required for the RTS-CTS exchange and the additional predetermined time period to the current time value to determine whether there is sufficient time for another one of the cycles.

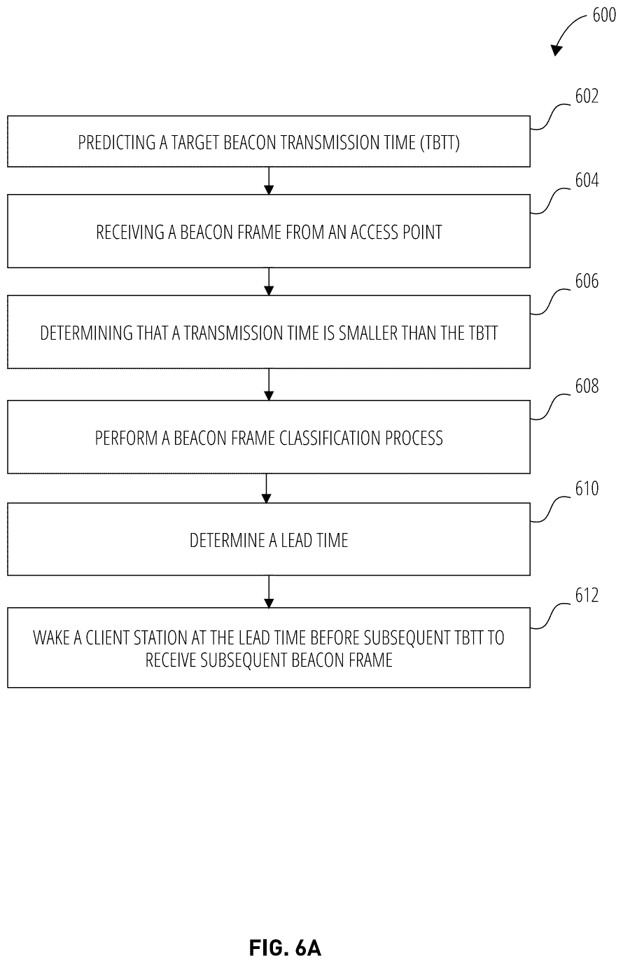

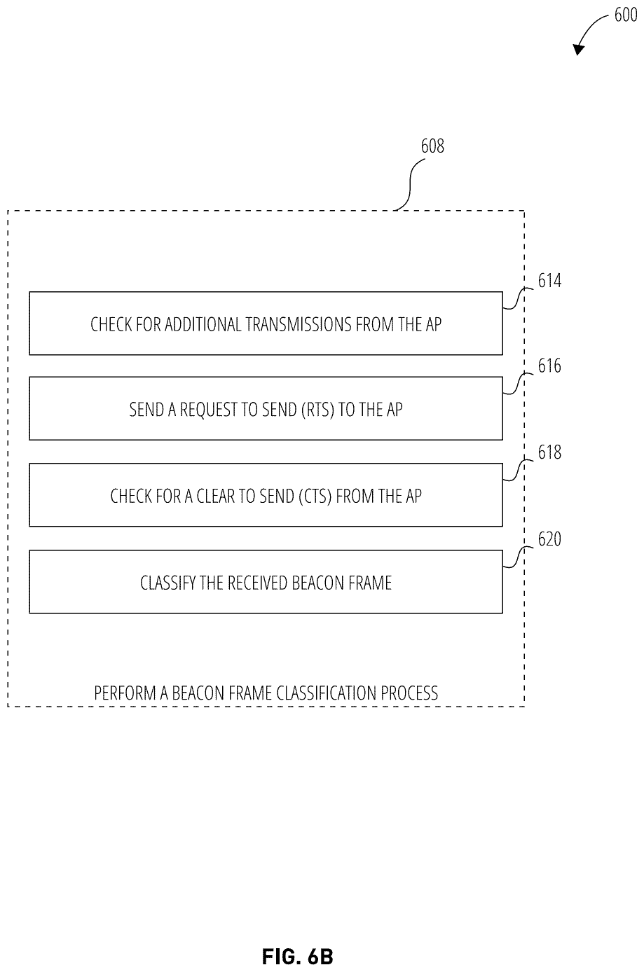

FIG. 6A is a flowchart showing method 600 for adaptive optimization of a wake-up schedule for a client station, according to some examples. The method 600 includes blocks 602, 604, 606, 608, 610, and 612. It should be understood that the blocks depicted in the flowchart are not limited to the specific order in which they are presented. The sequence of operations may vary, and not all blocks may be required for the execution of the process. Some blocks may be executed in a different order, performed concurrently, omitted entirely, or additional blocks may be included without departing from the scope of the disclosed method. The flowchart is provided for illustrative purposes only and should not be construed as a limitation on the methods or systems described herein. The described process is flexible and may be adapted to accommodate various implementations that are within the purview of one skilled in the art.

In block 602, the client station predicts a TBTT. The TBTT may be predicted by TBTT calculation component 208. TBTTs indicate the time at which beacon frames are scheduled to be transmitted. In some examples, TBTT calculation component 208 predetermines TBTTs. For example, TBTTs=(N+1) ×a predetermined beacon interval. N is an interval number corresponding to the beacon frame. For example, the first beacon frame transmitted by access point 104 has a corresponding interval number 1, and the second beacon frame transmitted by access point 104 has a corresponding interval number 2, and so on. In the example illustrated in FIG. 4, the TBTTs are 102.4, 204.8, 307.2, . . . , 819.2, and 921.6 milliseconds (ms), that is, a beacon frame is scheduled to be transmitted every 102.4 ms. In some examples, the current TBTT is determined based on the transmission time of the preceding beacon frame. In these examples, TBTT calculation component 208 determines a current beacon interval by performing a floor division of the transmission time of the preceding beacon frame by the predetermined beacon interval. For example: 110.0//102.4=1, wherein 110.0 is the transmission time of the preceding beacon frame and 102.4 is the predetermined beacon interval, and 1 indicates that the interval number corresponding to the preceding beacon frame is 1, and the interval number corresponding to the current beacon frame is 2 (i.e., 1+1), Hence, the current TBTT would be the 2×the predetermined beacon interval (i.e., 2×102.4=204.8). Client station 106 proceeds to block 604 in response to determining the current TBTT.

In block 604, client station 106 receives a beacon frame (i.e., the received beacon frame) from access point 104. The received beacon frame may be received by RX component 202 of client station 106 at or near the current TBTT. RX component 202 may include a transceiver for receiving data such as beacon frames from access point 104. Transmission time determination component 210 may determine the transmission time of the received beacon frame. In response to determining the transmission time, client station 106 proceeds to block 606.

In block 606, client station 106 determines that the transmission time of the received beacon frame is smaller than the predicted TBTT of the current beacon frame via beacon frame analyzing component 204. When the transmission time is smaller than the predicted TBTT, this suggests that the beacon frames may have been sent ahead of the TBTTs. However, further confirmation is required, since the received beacon frame could be a preceding beacon frame that was received ahead of the TBTT of the current beacon frame due to Internet traffic delays, not because a current beacon frame was sent ahead of its TBTT. Client station 106 proceeds to block 608 to confirm that the received beacon frame is a current beacon frame, not a preceding beacon frame.

In block 608, client station 106 performs a beacon frame classification process to determine whether the received beacon frame is a current beacon frame or a preceding beacon frame. The beacon frame classification process may be performed by beacon frame classifier 212. Beacon frame classifier 212 may determine that the received beacon frame is a current beacon frame based on a failure to detect additional beacon frame during the predetermined time period, because if the received beacon frame was a preceding beacon frame that was delayed, client station 106 should receive the additional beacon frame intended to be the current beacon frame some time afterward. Beacon frame classifier 212 may determine that the received beacon frame is a preceding beacon frame based on receiving the additional beacon frame during the predetermined time period. The details of the beacon frame classification process will be discussed further in the description of FIG. 6B. Client station 106 proceeds to block 610 in response to determining that the received beacon frame is the current beacon frame.

In block 610, client station 106 determines a lead time. The lead time determines how much before the TBTT client station 106 should exit the power-saving mode (i.e., wake up). The lead time may be determined by lead time determination component 214. In response to determining that the received beacon frame was a current beacon frame, indicating that the current beacon frame was indeed sent ahead of its TBTT, lead time determination component 214 may determine the lead time based on how much earlier than the current TBTT that the current beacon frame was transmitted and/or received. As explained above, the lead time may include one or more components. In some examples, one component of the lead time is determined based on a difference between the transmission time and the current TBTT. In some examples, the one component of the lead time=transmission time of the current beacon frame−current TBTT, obtaining a negative time for the one component. In these examples, assuming that other components of the lead time are 0, client station 106 wakes up subsequent TBTTs+lead time to prepare for receiving the subsequent beacon frame. In some other examples, lead time=current TBTT−transmission time of the current beacon frame, obtaining a positive time for the one component of the lead time. In these examples, again assuming that other components of the lead time are 0, client station 106 wakes up at subsequent TBTT−lead time to prepare for receiving the subsequent TBTT. In response to determining the lead time, client station 106 proceeds to block 612.

In some examples, client station 106 repeats blocks 602, 604, 606, 608, and 610 for a predetermined number of times to obtain multiple lead times. Lead time determination component 214 may select a lead time with the largest absolute value from the multiple lead times, minimizing a risk that client station 106 would wake up too late and miss a beacon frame.

In block 612, client station 106 wakes up from the power-saving mode based on the subsequent TBTT and the lead time. Client station 106 may be waked by sleep/wake controller 206. Sleep/wake controller 206 controls the timing of entering or exiting the power-saving mode. In some examples, sleep/wake controller 206 keeps track of time according to a client station's clock and instructs client station 106 to exit power-saving mode in response to the client station's clock reaching the wake-up times determined by TBTTs, lead times, and any additional time required to prepare the client station 106.

FIG. 6B is a flowchart showing further details of block 608, according to some examples. It should be understood that the blocks depicted in the flowchart are not limited to the specific order in which they are presented. The sequence of operations may vary, and not all blocks may be required for the execution of the process. Some blocks may be executed in a different order, performed concurrently, omitted entirely, or additional steps may be included without departing from the scope of the disclosed method. The flowchart is provided for illustrative purposes only and should not be construed as a limitation on the methods or systems described herein. The described process is flexible and may be adapted to accommodate various implementations that are within the purview of one skilled in the art.

In block 608, client station 106 performs the beacon frame classification process, which may include blocks 614, 616, 618, and 620.

In block 614, client station 106 checks for additional transmissions from access point 104 for the predetermined time period. The checking may be performed by beacon frame classifier 212. Client station 106 may check for a transmission of the additional beacon frame from access point 104 after receiving the received beacon frame. By checking for the transmission of the additional beacon frame, client station 106 can determine whether the received beacon frame is a current beacon frame or a preceding beacon frame that was delayed.

Client station 106 may check for additional transmissions from access point 104 by performing a Clear Channel Assessment (CCA). The CCA allows client station 106 to check for additional transmissions based on radio frequency (RF) signals and/or energy levels in the wireless medium: if RF signals and/or energy levels are above a predetermined threshold, client station 106 determines that there is one or more additional transmissions. Alternatively, if no RF signals and/or energy levels exceed the predetermined threshold, client station 106 determines that the wireless medium remains unoccupied when the CCA is performed. Client station 106 may perform the CCA for the predetermined time periods. In addition to the CCA, client station 106 may determine that there are one or more additional transmissions based on receiving data (e.g., receiving a beacon frame, a non-beacon packet, etc.) from access point 104.

Client station 106 may start block 614 to check for additional transmissions from access point 104 for the predetermined time period in response to receiving the received beacon frame from access point 104. Alternatively, client station 106 may start block 614 in response to receiving the CTS from access point 104 in block 618, which will be discussed below. Optionally, in response to receiving an additional transmission from access point 104 or expiration of the predetermined time period, client station 106 may proceed to block 620.

In one example, client station 106 receives no additional transmission based on determining that the wireless medium is unoccupied during the predetermined time period and proceeds to block 616.

In another example, client station 106 receives the additional beacon frame intended for the current TBTT, indicating that the received beacon frame is a preceding beacon frame that was delayed. Client station 106 proceeds to block 620 to classify that the received beacon frame is a preceding beacon frame and proceeds to block 610.

In a further example, client station 106 receives a non-beacon packet. Client station 106 continues performing the CCA to check for additional transmissions during the predetermined time period.

In block 616, client station 106 may send an RTS to access point 104. As discussed above, by sending the RTS to access point 104, access point 104 may send the CTS in response and then send the pending beacon frame that was not sent due to a busy wireless medium. In other words, if there is an additional beacon frame intended for the current TBTT, sending the RTS would cause access point 104 to send the additional beacon frame after the CTS. Client station 106 may proceed to block 618 in response to sending the RTS.

In some examples, prior to sending the RTS to access point 104, client station 106 determines whether there is sufficient remaining time before the subsequent TBTT to complete the cycle of sending the RTS, receiving the CTS from access point 104, and checking for the additional transmissions during the predetermined time period. If yes, client station 106 may proceeds to send the RTS and to block 618; if no, client station 106 may terminate the beacon frame classification process and prepare for receiving the subsequent beacon frame.

In block 618, client station 106 checks for the CTS from access point 104. The checking for the CTS may be performed by RX component 202. In one example, the client station 106 receives the CTS and starts block 614 to check for additional transmissions from access point 104 because the additional beacon frame may be transmitted by the access point 104. In another example, client station 106 fails to receive the CTS from access point 104, indicating that access point 104 is in communication with other client stations in network 102, and client station 106 may either end the beacon frame classification process or restart the beacon frame classification process.

In block 620, client station 106 classifies the received beacon frame as either a current beacon frame or a preceding beacon frame based on the additional transmission (e.g., additional beacon frame and non-beacon packet) or lack thereof, from access point 104 during the predetermined time period(s).

In some examples, beacon frame classifier 212 classifies that the received beacon frame as the current beacon frame based on no additional transmission has occurred during the predetermined time period(s) and ends the beacon frame classification process.

In some other examples, beacon frame classifier 212 classifies the received beacon frame as the preceding beacon frame based on client station 106 receiving the additional beacon frame intended for the current TBTT. Client station 106 then proceeds to block 610.

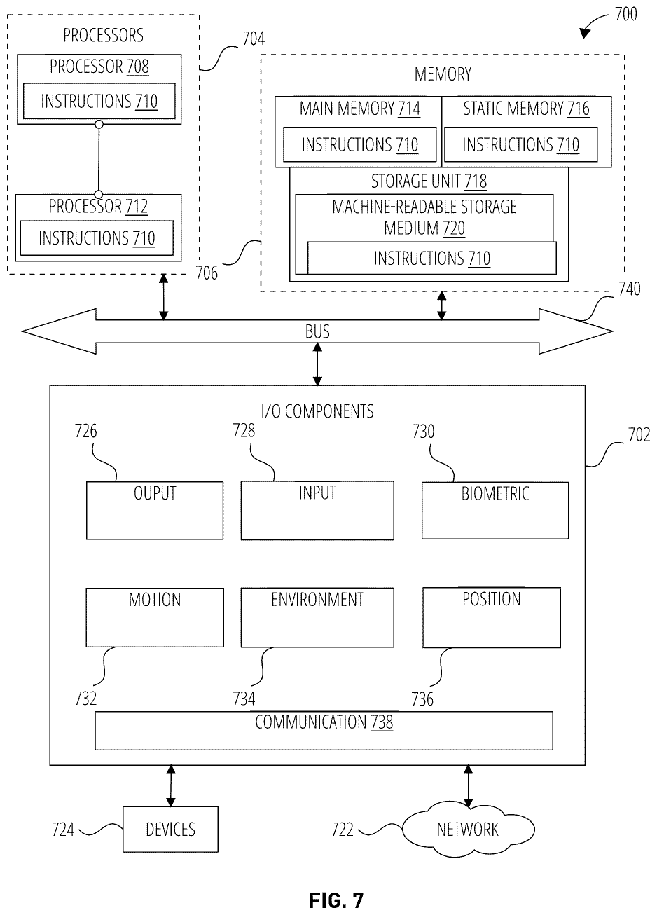

FIG. 7 is a diagrammatic representation of the client station 700 within which instructions 710 (e.g., software, a program, an application, an applet, an app, or other executable code) for causing the client station 700 to perform any one or more of the methodologies discussed herein may be executed. For example, the instructions 710 may cause the client station 700 to execute any one or more of the methods described herein. The instructions 710 transform the general, non-programmed client station 700 into a particular client station 700 programmed to carry out the described and illustrated functions in the manner described. The client station 700 may operate as a standalone device or be coupled (e.g., networked) to other machines. In a networked deployment, the client station 700 may operate in the capacity of a server machine or a client machine in a server-client network environment, or as a peer machine in a peer-to-peer (or distributed) network environment. The client station 700 may include, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the client station 700. Further, while a single client station 700 is illustrated, the term “machine” may include a collection of machines that individually or jointly execute the instructions 710 to perform any one or more of the methodologies discussed herein.

The client station 700 may include processors 704, memory 706, and I/O components 702, which may be configured to communicate via a bus 740. In some examples, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 708 and a Processor 712 that execute the instructions 710. The term “Processor” is intended to include multi-core processors that may include two or more independent processors (sometimes referred to as “cores”) that may execute instructions 710 contemporaneously. Although FIG. 7 shows multiple processors 704, the client station 700 may include a single processor with a single core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 706, the static memory 716, and storage unit 718 store the instructions 710 embodying any one or more of the methodologies or functions described herein. The instructions 710 may also reside, wholly or partially, within the main memory 714, within the static memory 716, within machine-readable storage medium 720 within the storage unit 718, within the processors 704 (e.g., within the processor's cache memory), or any suitable combination thereof, during execution thereof by the client station 700.

The I/O components 702 may include various components to receive input, provide output, produce output, transmit information, exchange information, or capture measurements. The specific I/O components 702 included in a particular machine depend on the type of machine. For example, portable machines such as mobile phones may include a touch input device or other such input mechanisms, while a headless server machine will likely not include such a touch input device. The I/O components 702 may include many other components not shown in FIG. 7. In various examples, the I/O components 702 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 702 may include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 732 include acceleration sensor components (e.g., accelerometer), gravitation sensor components, rotation sensor components (e.g., gyroscope). The environmental components 734 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 736 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 further include communication components 738 operable to couple the client station 700 to a network 722 or devices 724 via respective coupling or connections. For example, the communication components 738 may include a network interface Component or another suitable device to interface with the network 722. In further examples, the communication components 738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 724 may be another machine or any of a wide variety of peripheral devices (e.g., a peripheral device coupled via a USB).

Moreover, the communication components 738 may detect identifiers or include components operable to detect identifiers. For example, the communication components 738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 738, such as location via Internet Protocol (IP) geolocation, location via Wi-Fi® signal triangulation, or location via detecting an NFC beacon signal that may indicate a particular location.

The various memories (e.g., main memory 714, static memory 716, and/or memory of the processors 704) and/or storage unit 718 may store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 may be transmitted or received over the network 722, using a transmission wireless medium, via a network interface device (e.g., a network interface component included in the communication components 738) and using any one of several well-known transfer protocols (e.g., hypertext transfer protocol (HTTP)). Similarly, the instructions 710 may be transmitted or received using a transmission medium via a coupling (e.g., a peer-to-peer coupling) to the devices 724.

The systems and methods described provide effective techniques for adaptive optimization of the wake-up schedule of a client station in wireless networks. By analyzing the transmission times of received beacon frames and classifying them, the client station determines if the access point transmits beacon frames ahead of target times. Once detected, the client station calculates a lead time based on the time differences. Using this lead time allows the client station to wake up early enough to reliably receive beacon frames while minimizing unnecessary power usage.

Key advantages may include: optimizing the client station's wake-up schedule to match the access point's early beacon frames, reducing client station power consumption by avoiding early exiting power-saving mode. Overall, the invention adaptively optimizes client station wake-up schedules for efficient and reliable wireless communication.

The following are example systems and methods for adaptive optimization of wake-up schedule of a client station in wireless networks:

Example 1 is a method, comprising: predicting, by one or more processors of a client station, a target beacon transmission time (TBTT); receiving, by a transceiver of the client station, a beacon frame from an access point, the beacon frame comprising a transmission time according to an access point's clock; determining, by the one or more processors of the client station, that the transmission time is smaller than the TBTT, indicating that the beacon frame is sent ahead of the TBTT; performing, by the one or more processors of the client station, a beacon frame classification process in response to determining that the transmission time is smaller than the TBTT; determining, by the one or more processors of the client station, that the access point sends beacon frames ahead of TBTTs based on the received beacon frame is determined to be a current beacon frame in the beacon frame classification process; determining, by the one or more processors of the client station, a lead time based on the transmission time and the TBTT; and waking, by the one or more processors of the client station, the client station at the lead time before subsequent TBTTs to receive subsequent beacon frames.

In Example 2, the subject matter of Example 1 includes, repeating the predicting, receiving, determining that the transmission time is smaller than the TBTT, performing, determining that the access point sends the beacon frames ahead of the TBTTs, and determining the lead time for a predetermined number of times, thereby obtaining multiple lead times; and selecting a lead time with a largest absolute value from the multiple lead times as the lead time.

In Example 3, the subject matter of Examples 1-2 includes, wherein the beacon frame classification process comprises: determining that a wireless medium has remained unoccupied for a predetermined time period comprising a Distributed InterFrame Space (DIFS) and a Contention Window Maximum (CWMax); and determining that the wireless medium has remained unoccupied for the predetermined time period, indicating the received beacon frame is the current beacon frame.

In Example 4, the subject matter of Examples 1-3 includes, wherein the beacon frame classification process comprises: determining that a wireless medium has remained unoccupied for a first predetermined time period comprising a Distributed InterFrame Space (DIFS) and a Contention Window Maximum (CWMax); sending a Request to Send (RTS) to the access point; checking for a Clear to Send (CTS) from the access point; checking for an additional beacon frame during a subsequent predetermined time period equal to the first predetermined time period; and detecting a failure to receive the additional beacon frame during the subsequent predetermined time period, indicating the received beacon frame is the current beacon frame.

In Example 5, the subject matter of Examples 1-4 includes, wherein the beacon frame classification process comprises: determining that a wireless medium has remained unoccupied for a first predetermined time period comprising a Distributed InterFrame Space (DIFS) and a Contention Window Maximum (CWMax); sending a Request to Send (RTS) to the access point; checking for a Clear to Send (CTS) from the access point; checking for an additional beacon frame during a subsequent predetermined time period equal to the first predetermined time period; detecting a failure to receive the additional beacon frame during the subsequent predetermined time period; repeating the sending, checking for the CTS, and checking for the additional beacon frame one or more times; and obtaining multiple failure detections through the repeated sending, checking for the CTS, and checking for the additional beacon frame, indicating that the received beacon frame is the current beacon frame.

In Example 6, the subject matter of Examples 1-5 includes, wherein the beacon frame classification process comprises: determining that a wireless medium has remained unoccupied for a first predetermined time period comprising a Distributed InterFrame Space (DIFS) and a Contention Window Maximum (CWMax); sending a Request to Send (RTS) to the access point; checking for a Clear to Send (CTS) from the access point; checking for an additional beacon frame during a subsequent predetermined time period equal to the first predetermined time period; and receiving the additional beacon frame from the access point during the subsequent predetermined time period; and determining that the received beacon frame is a preceding beacon frame in response to receiving the additional beacon frame.

In Example 7, the subject matter of Examples 1-6 includes, wherein the beacon frame classification process comprises: determining that a wireless medium has remained unoccupied for a first predetermined time period comprising a Distributed InterFrame Space (DIFS) and a Contention Window Maximum (CWMax); sending a Request to Send (RTS) to the access point; checking for a Clear to Send (CTS) from the access point; checking for an additional beacon frame during a subsequent predetermined time period equal to the first predetermined time period; receiving a non-beacon packet from the access point during the subsequent predetermined time period; repeating the sending, checking for the CTS, and checking for the additional beacon frame one or more times; and detecting a failure to receive the additional beacon frame during one or more subsequent predetermined time period, indicating the received beacon frames is the current beacon frame.

In Example 8, the subject matter of Example 7 includes, predicting a subsequent TBTT of a subsequent beacon frame; determining a time required for an RTS-CTS exchange; determining that there is sufficient time for the RTS-CTS exchange and checking for the additional beacon frame based on the time required for the RTS-CTS exchange and a predetermined time period before the repeating.

In Example 9, the subject matter of Examples 1-8 includes, wherein the beacon frame classification process comprises: determining that a wireless medium has remained unoccupied for a first predetermined time period comprising a Distributed InterFrame Space (DIFS) and a Contention Window Maximum (CWMax); sending a Request to Send (RTS) to the access point; detecting a failure to receive a Clear to Send (CTS) from the access point; and terminating the beacon frame classification process in response to detecting the failure to receive the CTS.

In Example 10, the subject matter of Examples 1-9 includes, wherein the beacon frame classification process comprises: receiving an additional beacon frame from the access point; and determining that the received beacon frame is a preceding beacon frame in response to receiving the additional beacon frame.

Example 11 is a client station comprising means to implement of any of Examples 1-10.

Example 12 is at least one machine-readable medium including instructions that, when executed by processing circuitry, cause the processing circuitry to perform operations to implement of any of Examples 1-10.

What is claimed is:

1. A method, comprising:
predicting, by one or more processors of a client station, a target beacon transmission time (TBTT);
receiving, by a transceiver of the client station, a beacon frame from an access point, the beacon frame comprising a transmission time according to an access point's clock;
determining, by the one or more processors of the client station, that the transmission time is smaller than the TBTT, indicating that the beacon frame is sent ahead of the TBTT;
performing, by the one or more processors of the client station, a beacon frame classification process in response to determining that the transmission time is smaller than the TBTT;
determining, by the one or more processors of the client station, that the access point sends beacon frames ahead of TBTTs based on the received beacon frame is determined to be a current beacon frame in the beacon frame classification process;
determining, by the one or more processors of the client station, a lead time based on the transmission time and the TBTT; and
waking, by the one or more processors of the client station, the client station at the lead time before subsequent TBTTs to receive subsequent beacon frames.

2. The method of claim 1, further comprising:
repeating the predicting, receiving, determining that the transmission time is smaller than the TBTT, performing, determining that the access point sends the beacon frames ahead of the TBTTs, and determining the lead time for a predetermined number of times, thereby obtaining multiple lead times; and
selecting a lead time with a largest absolute value from the multiple lead times as the lead time.

3. The method of claim 1, wherein the beacon frame classification process comprises:
determining that a wireless medium has remained unoccupied for a predetermined time period comprising a Distributed InterFrame Space (DIFS) and a Contention Window Maximum (CWMax); and
determining that the wireless medium has remained unoccupied for the predetermined time period, indicating the received beacon frame is the current beacon frame.

4. The method of claim 1, wherein the beacon frame classification process comprises:
determining that a wireless medium has remained unoccupied for a first predetermined time period comprising a Distributed InterFrame Space (DIFS) and a Contention Window Maximum (CWMax);
sending a Request to Send (RTS) to the access point;
checking for a Clear to Send (CTS) from the access point;
checking for an additional beacon frame during a subsequent predetermined time period equal to the first predetermined time period; and
detecting a failure to receive the additional beacon frame during the subsequent predetermined time period, indicating the received beacon frame is the current beacon frame.

5. The method of claim 1, wherein the beacon frame classification process comprises:
determining that a wireless medium has remained unoccupied for a first predetermined time period comprising a Distributed InterFrame Space (DIFS) and a Contention Window Maximum (CWMax);
sending a Request to Send (RTS) to the access point;
checking for a Clear to Send (CTS) from the access point;
checking for an additional beacon frame during a subsequent predetermined time period equal to the first predetermined time period;
detecting a failure to receive the additional beacon frame during the subsequent predetermined time period;
repeating the sending, checking for the CTS, and checking for the additional beacon frame one or more times; and
obtaining multiple failure detections through the repeated sending, checking for the CTS, and checking for the additional beacon frame, indicating that the received beacon frame is the current beacon frame.

6. The method of claim 1, wherein the beacon frame classification process comprises:
determining that a wireless medium has remained unoccupied for a first predetermined time period comprising a Distributed InterFrame Space (DIFS) and a Contention Window Maximum (CWMax);
sending a Request to Send (RTS) to the access point;
checking for a Clear to Send (CTS) from the access point;
checking for an additional beacon frame during a subsequent predetermined time period equal to the first predetermined time period; and
receiving the additional beacon frame from the access point during the subsequent predetermined time period; and
determining that the received beacon frame is a preceding beacon frame in response to receiving the additional beacon frame.

7. The method of claim 1, wherein the beacon frame classification process comprises:
determining that a wireless medium has remained unoccupied for a first predetermined time period comprising a Distributed InterFrame Space (DIFS) and a Contention Window Maximum (CWMax);
sending a Request to Send (RTS) to the access point;
checking for a Clear to Send (CTS) from the access point;
checking for an additional beacon frame during a subsequent predetermined time period equal to the first predetermined time period;
receiving a non-beacon packet from the access point during the subsequent predetermined time period;
repeating the sending, checking for the CTS, and checking for the additional beacon frame one or more times; and
detecting a failure to receive the additional beacon frame during one or more subsequent predetermined time period, indicating the received beacon frames is the current beacon frame.

8. The method of claim 7, further comprising:
predicting a subsequent TBTT of a subsequent beacon frame;
determining a time required for an RTS-CTS exchange;
determining that there is sufficient time for the RTS-CTS exchange and checking for the additional beacon frame based on the time required for the RTS-CTS exchange and a predetermined time period before the repeating.

9. The method of claim 1, wherein the beacon frame classification process comprises:
determining that a wireless medium has remained unoccupied for a first predetermined time period comprising a Distributed InterFrame Space (DIFS) and a Contention Window Maximum (CWMax);
sending a Request to Send (RTS) to the access point;
detecting a failure to receive a Clear to Send (CTS) from the access point; and
terminating the beacon frame classification process in response to detecting the failure to receive the CTS.

10. The method of claim 1, wherein the beacon frame classification process comprises:
receiving an additional beacon frame from the access point; and
determining that the received beacon frame is a preceding beacon frame in response to receiving the additional beacon frame.

11. A client station comprising:
one or more processors; and
a non-transitory memory storing instructions that, when executed by the one or more processors, configure the one or more processors to:
predict a target beacon transmission time (TBTT);
receive, by a transceiver of the client station, a beacon frame from an access point, the beacon frame comprising a transmission time according to an access point's clock;
determine that the transmission time is smaller than the TBTT, indicating that the beacon frame is sent ahead of the TBTT;
perform a beacon frame classification process in response to determining that the transmission time is smaller than the TBTT;
determine that the access point sends beacon frames ahead of TBTTs based on the received beacon frame is determined to be a current beacon frame in the beacon frame classification process;
determine a lead time based on the transmission time and the TBTT; and
wake the client station at the lead time before subsequent TBTTs to receive subsequent beacon frames.

12. The client station of claim 11, wherein the instructions further configure the client station to:
repeat the predicting, receiving, determining that the transmission time is smaller than the TBTT, performing, determining that the access point sends the beacon frames ahead of the TBTTs, and determining the lead time for a predetermined number of times, thereby obtaining multiple lead times; and
select a lead time with a largest absolute value from the multiple lead times as the lead time.

13. The client station of claim 11, wherein the beacon frame classification process comprises:
determine that a wireless medium has remained unoccupied for a predetermined time period comprising a Distributed InterFrame Space (DIFS) and a Contention Window Maximum (CWMax); and
determine that the wireless medium has remained unoccupied for the predetermined time period, indicating the received beacon frame is the current beacon frame.

14. The client station of claim 11, wherein the beacon frame classification process comprises:
determine that a wireless medium has remained unoccupied for a first predetermined time period comprising a Distributed InterFrame Space (DIFS) and a Contention Window Maximum (CWMax);
send a Request to Send (RTS) to the access point;
check for a Clear to Send (CTS) from the access point;
check for an additional beacon frame during a subsequent predetermined time period equal to the first predetermined time period; and
detect a failure to receive the additional beacon frame during the subsequent predetermined time period, indicating the received beacon frame is the current beacon frame.

15. The client station of claim 11, wherein the beacon frame classification process comprises:
determine that a wireless medium has remained unoccupied for a first predetermined time period comprising a Distributed InterFrame Space (DIFS) and a Contention Window Maximum (CWMax);
send a Request to Send (RTS) to the access point;
check for a Clear to Send (CTS) from the access point;
check for an additional beacon frame during a subsequent predetermined time period equal to the first predetermined time period;
detect a failure to receive the additional beacon frame during the subsequent predetermined time period;
repeat the sending, checking for the CTS, and checking for the additional beacon frame one or more times; and
obtain multiple failure detections through the repeated sending, checking for the CTS, and checking for the additional beacon frame, indicating that the received beacon frame is the current beacon frame.

16. The client station of claim 11, wherein the beacon frame classification process comprises:
determine that a wireless medium has remained unoccupied for a first predetermined time period comprising a Distributed InterFrame Space (DIFS) and a Contention Window Maximum (CWMax);
send a Request to Send (RTS) to the access point;
check for a Clear to Send (CTS) from the access point;
check for an additional beacon frame during a subsequent predetermined time period equal to the first predetermined time period; and
receive the additional beacon frame from the access point during the subsequent predetermined time period; and
determine that the received beacon frame is a preceding beacon frame in response to receiving the additional beacon frame.

17. The client station of claim 11, wherein the beacon frame classification process comprises:
determine that a wireless medium has remained unoccupied for a first predetermined time period comprising a Distributed InterFrame Space (DIFS) and a Contention Window Maximum (CWMax);
send a Request to Send (RTS) to the access point;
check for a Clear to Send (CTS) from the access point;
check for an additional beacon frame during a subsequent predetermined time period equal to the first predetermined time period;
receive a non-beacon packet from the access point during the subsequent predetermined time period;
repeat the sending, checking for the CTS, and checking for the additional beacon frame one or more times; and
detect a failure to receive the additional beacon frame during one or more subsequent predetermined time period, indicating the received beacon frames is the current beacon frame.

18. The client station of claim 17, wherein the beacon frame classification process comprises:
predict a subsequent TBTT of a subsequent beacon frame;
determine a time required for an RTS-CTS exchange;
determine that there is sufficient time for the RTS-CTS exchange and check for the additional beacon frame based on the time required for the RTS-CTS exchange and a predetermined time period before the repeating.

19. The client station of claim 11, wherein the beacon frame classification process comprises:
determine that a wireless medium has remained unoccupied for a first predetermined time period comprising a Distributed InterFrame Space (DIFS) and a Contention Window Maximum (CWMax);
send a Request to Send (RTS) to the access point;
detect a failure to receive a Clear to Send (CTS) from the access point; and
terminate the beacon frame classification process in response to detecting the failure to receive the CTS.

20. A non-transitory computer-readable storage medium including instructions that when executed by one or more processors of a client station, cause the client station to:
predict a target beacon transmission time (TBTT);
receive, by a transceiver of the client station, a beacon frame from an access point, the beacon frame comprising a transmission time according to an access point's clock;
determine that the transmission time is smaller than the TBTT, indicating that the beacon frame is sent ahead of the TBTT;
perform a beacon frame classification process in response to determining that the transmission time is smaller than the TBTT;
determine that the access point sends beacon frames ahead of TBTTs based on the received beacon frame is determined to be a current beacon frame in the beacon frame classification process;
determine a lead time based on the transmission time and the TBTT; and
wake the client station at the lead time before subsequent TBTTs to receive subsequent beacon frames.
